(19) United States
(12) Patent Application Publication
(10) Pub. No.: US 2010/0205963 A1
(43) Pub. Date: Aug. 19, 2010

(54) CONCENTRATED SOLAR POWER GENERATION SYSTEM WITH DISTRIBUTED GENERATION

(76) Inventor: Danny F. Ammar, Windermere, FL (US)

Correspondence Address: GRAY ROBINSON, P.A., P.O. Box 2328, FT. LAUDERDALE, FL, 33303-9998, US

(21) Appl. No.: 12/770,194

(22) Filed: Apr. 29, 2010

Related U.S. Application Data
(63) Continuation-in-part of application No. 12/198,219, filed on Aug. 26, 2008.

(51) Int. Cl. F03G 6/06; F24J 2/42; F24J 2/38

(52) U.S. Cl. 60/641.15; 126/628; 126/601

(57) ABSTRACT

A small scale, concentrated solar power generation system includes a solar field of parabolic reflectors that may be located in proximity to load centers such that waste heat from the generation system may be employed in distributed, auxiliary applications.

### CROSS-REFERENCE TO RELATED APPLICATIONS

This application is a continuation-in-part application of U.S. patent application Ser. No. 12/198,219 filed Aug. 26, 2008 and entitled “Linear Solar Energy Collection System” and is expressly incorporated herein by reference in its entirety to form part of the present disclosure.

### FIELD OF THE INVENTION

This invention relates to the generation of electrical energy through solar thermal power collection, and, more particularly, to a concentrated solar power generation system with distributed generation.

### BACKGROUND OF THE INVENTION

Systems for the generation, of electricity by collecting solar thermal radiation were first introduced in 1914, and have become increasingly popular with the rise in fossil fuel costs and concerns over global warming. The majority of solar energy collection systems currently in use are of the type depicted in FIGS. 1 and 2. A generally parabolic-shaped trough 10 is provided having a curved, reflective surface 12 that is typically formed of a number of mirrors. The reflective surface 12 is effective to concentrate and reflect incident sunlight 13 at thirty to eighty times its normal intensity along a focal line that is coincident with a receiver tube 14 mounted by holding bars 16 in a position above the reflective surface 12. The mirrors are carried by a support structure 18 which, in turn, is connected at each end to pylons 20 secured in the ground on a concrete foundation or the like. A motor 22 is drivingly connected to the support structure 12 to pivot it thus allowing the reflective surface 12 to track the progress of the sun across the sky. A local controller 24 may be provided to control the operation of the motor 22 as it pivots the support structure 18 and surface 12 throughout a day, and to monitor certain alarm conditions.

A heat transfer fluid is circulated through the receiver tube 14 which is heated by the sunlight reflected from surface 12. This fluid is used to generate steam which powers a turbine that drives an electric generator. In order to transfer the heated fluid from the receiver tube 14 to a steam generator, a flexible hose 26 is coupled to the receiver tube 14, typically via ball joints 28, and moves with it as the support structure 18 is pivoted. The flexible hose 26 may be connected to a header pipe (not shown), which then connects to the steam generator.

Solar collection systems of the type described above suffer from a number of deficiencies. The mirrors forming the reflective surface 12 typically comprise 4 mm low-iron float glass mirrors thermally sagged during manufacturing into a parabolic shape. These mirrors are very heavy, and are available from only a few manufacturers. They are difficult to install and require robust mounting structure to support in order to provide for accurate positioning of the reflective surface 12 and to resist wind loads. While thinner glass mirrors have been suggested as an alternative, they are more fragile resulting in increased handling costs and breakage losses. Most support structures 18 for the mirrors are formed of galvanized steel which is also heavy, requires precise manufacturing and is expensive to build. Bridge trusses have been employed in more recent designs for the support structures 18, but have proven to be nearly equally expensive to manufacture and often are lacking in torsional stiffness. In addition to these problems, the flexible hoses 26 and ball joints 28 employed to transfer heated fluid from the receiver tube 14 have high thermal losses, and exhibit high failure rates and leaks since they must move with the support structure 18 and reflective surface 12 as they pivot.

The goal of any solar collection system is to reduce the cost of electricity generated. There are fundamentally two ways to do this, namely, reduce the cost of the solar field and annual operating expenses, and, to increase system efficiency. Solar field optical efficiency is dependent upon a number of factors, including, without limitation, sunlight incident angle effects, collector tracking error, the geometric accuracy of the mirrors to focus light on the receiver tubes, mirror reflectivity, cleanliness of the mirrors, the creation of shadows across the mirrors, transmittance of solar energy into the receiver tubes, cleanliness of the receiver tubes, absorption of solar energy by the receiver tubes, end losses and the creation of shadows between rows of mirrors. In addition to these considerations, it has been generally accepted that concentrated solar power systems could only be cost-effective in large scale configurations employing hundreds, if not thousands of collectors, spread over an expansive area typically remotely located from the cities, factories or other load centers in need of the power.

### SUMMARY OF THE INVENTION

This invention is directed to a concentrated solar power generation system of comparatively small scale, e.g. up to about 5 megawatts, that may be located in proximity to load centers such that waste heat from the generation system may be employed in distributed, auxiliary applications.

More than 1.5 billion people live in areas of the world in which the lack of electrical transmission capability, the lack of conventional fuels and/or the lack of money deprive them of electrical power. Solar collection and power generation systems of the type described above, while capable of producing on the order of 50 megawatts of power, often require more than 500 acres of land, take 2-4 years to build and can cost $500 million dollars or more to construct. Such an investment of time and money is beyond the resources of many countries of the world where the need for electrical power is most severe.

This invention is predicated on the concept of providing a “mini” concentrated solar collection and power system with the added benefit of distributive power generation. In the presently preferred embodiment, small reflector units that may be placed in a compact area, e.g. 10 acres or less, are located in proximity to a load center such as a city, factory or the like. This eliminates the challenges and costs of transmission of the electrical power over long distances, which is typical with large-scale solar power generation and electrical plants that employ fossil or nuclear fuels. Additionally, because the system of this invention is located near load centers, waste heat in the form of steam and/or heated water discharged from the system may be employed in a variety of auxiliary devices or applications such as desalination units, heating systems for buildings and other applications.

In the presently preferred embodiment, the concentrated solar power system of this invention comprises a number of reflector units each fabricated using light-weight materials arranged in a construction that is highly accessible, easily maintained, and lower in initial cost. In one embodiment, each reflector unit includes a light-weight aluminum frame that mounts a number of solar panels in a fixed position at angles progressively increasing from the center of the frame outwardly to its perimeter so as to collectively form a surface having a shape approximating that of a parabola. The focal line of such parabola is coincident with a receiver tube mounted in a fixed position substantially concentric to the centerline of the frame. The frame is supported by a torsion bar to add rigidity, and is connected to a drive mechanism operative to pivot the frame in order to track the position of the sun during the course of a day. A number of individual reflector units may be arranged side-by-side to form a collection field of desired size.

Preferably, each solar panel comprises a honeycomb aluminum section and a highly reflective silver-metallized surface connected together by an adhesive layer. The solar panels are strong, durable, light-weight and efficiently reflect incident sunlight many times its normal intensity onto the secondary reflector.

A heat transfer fluid is circulated through the receiver tube for heating by the sunlight reflected onto such tube. Because the receiver tube is fixed relative to the pivoting frame, it may be connected to a fixed transfer conduit that communicates with an electric power generation system. Since both the receiver tube and transfer conduit are mounted in a fixed position, heat losses resulting from the transfer of fluid out of the receiver tube are minimized and maintenance problems with the moving connections between the receiver tube and transfer conduit that were required in prior art systems, as described above, are substantially eliminated.

In alternative embodiments, a reflector unit includes solar panels oriented in a different shape than parabolic but fixed to a light-weight, multi-segment aluminum frame in a position to reflect incident sunlight onto a receiver tube. A drive mechanism is employed to pivot the frame and reflective panels of these alternative reflector units in order to track the position of the sun during the course of a day.

### BRIEF DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is perspective view of a prior art solar energy collection system;

FIG. 2 is an end view of the system shown in FIG. 1;

FIG. 3 is a front perspective view of one embodiment of a reflector unit for the solar energy collection system of this invention;

FIG. 4 is a rear perspective view of the reflector unit shown in FIG. 3:

FIG. 5 is a perspective view of the solar panel of this invention;

FIG. 6 is an enlarged view of the encircled portion of FIG. 5 showing the solar panel partially disassembled;

FIG. 7 is a perspective view of the receiver tube employed herein;

FIG. 8 is a schematic, end view of the solar panels and receiver tube of the unit depicted in FIGS. 3 and 4, illustrating the orientation of the solar panels;

FIG. 9 is a schematic end view of an alternative embodiment of a reflector unit according to this invention;

FIG. 10 is a schematic end view of a still further embodiment of a reflector unit herein;

FIG. 11 is a perspective view of a portion of the drive mechanism for pivoting the frame and solar panels;

FIG. 12 is a schematic view of a concentrated solar power generation system of this invention; and

FIG. 13 is a schematic view of a desalination unit that may be employed as an auxiliary device for use of the waste heat produced by the system herein.

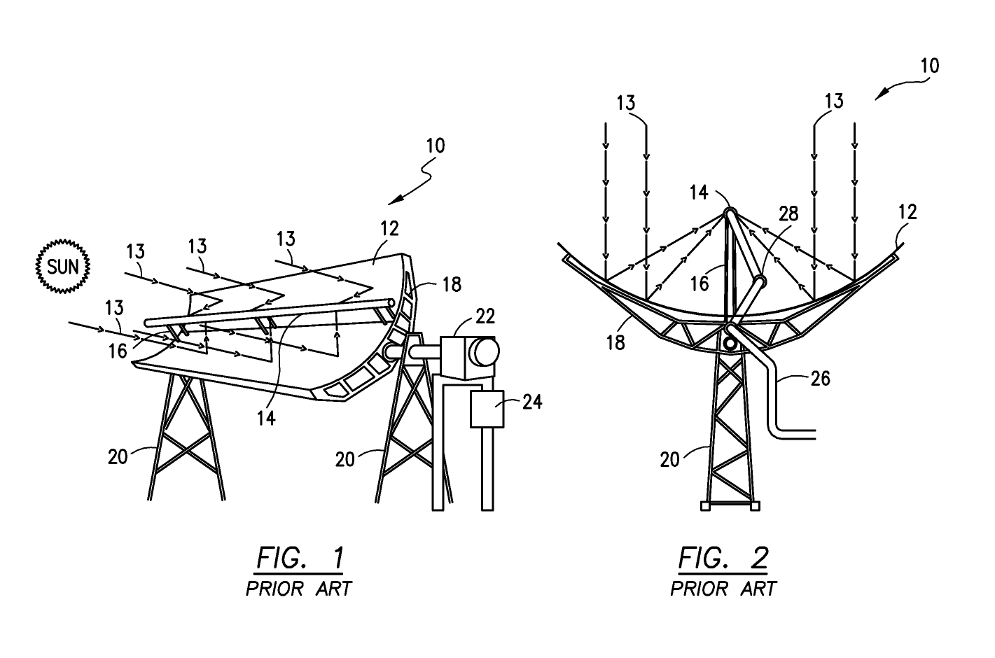

### DETAILED DESCRIPTION OF THE INVENTION

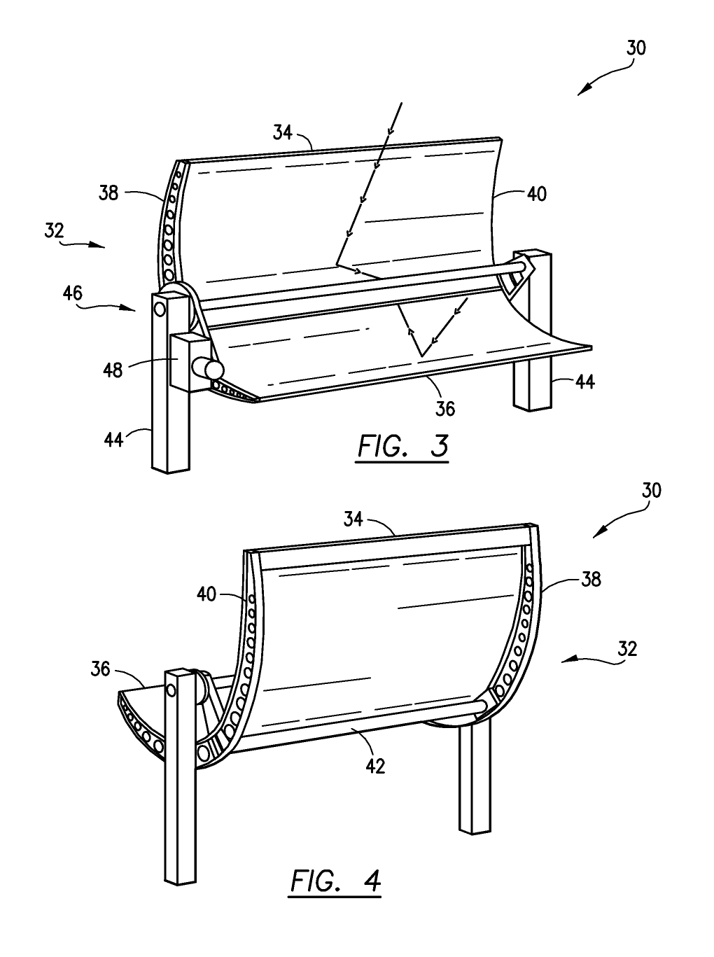

Referring now to FIGS. 3-8, one embodiment of a concentrated solar power generation system according to this invention is illustrated which may comprise several individual reflector units 30 oriented side-by-side. The reflector unit 30 is initially generally described, followed by a discussion of individual aspects of the design.

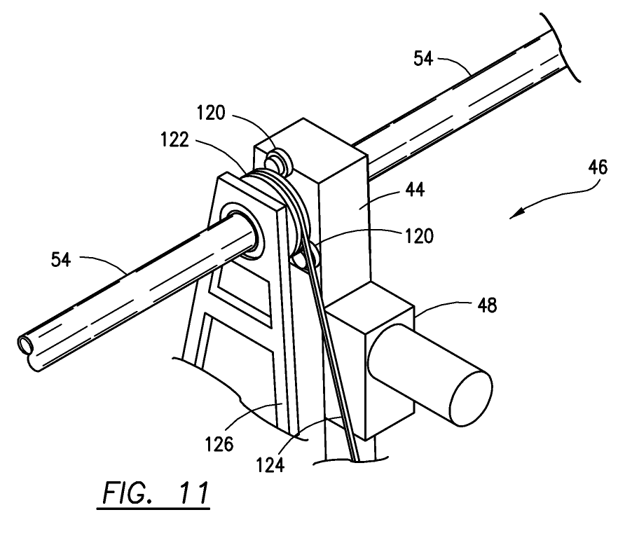

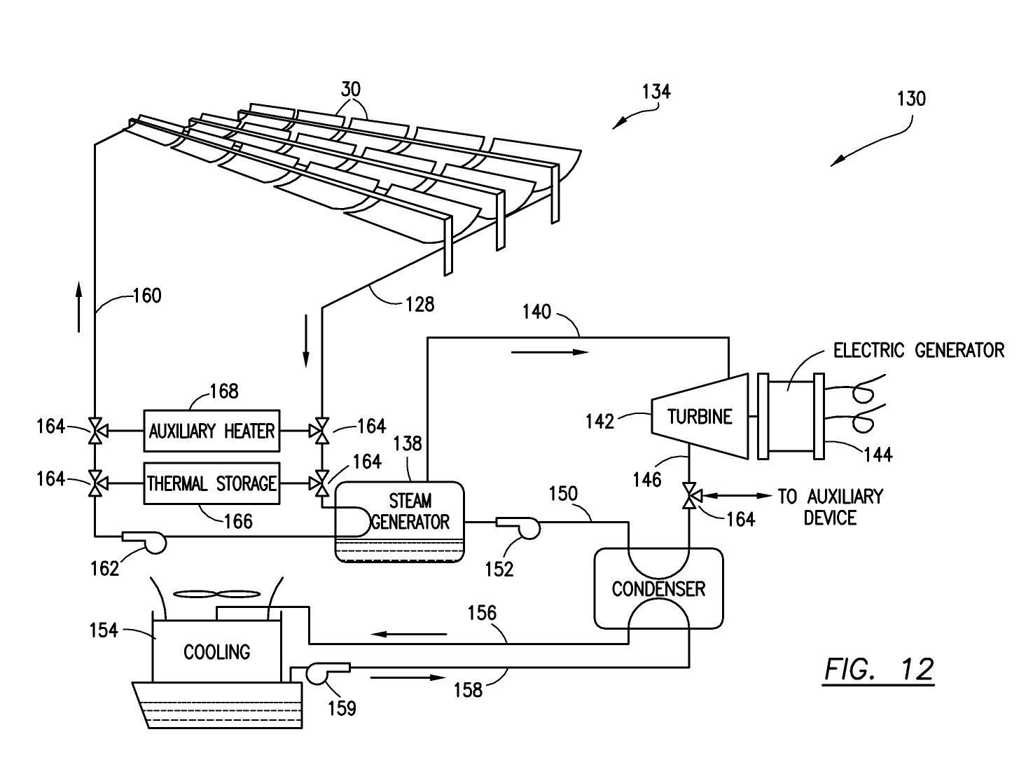

The reflector unit 30 includes a frame 32 having opposed side walls 34, 36, and opposed end walls 38, 40 connected together in a generally parabolic shape. The walls 34-40 are preferably formed of aluminum or other light-weight, weather resistant and durable material. The frame 32 is reinforced by a torsion bar 42, connected between the end walls 38, 40, which is also preferably formed of aluminum or similar material. The frame 32 may be supported above ground level by pylons 44 secured on a foundation such as concrete footers (not shown) that can support the weight of the unit 30 and wind loading applied to it. As described below with reference to FIG. 11, the frame 32 is pivotally mounted to the pylons 44 and may be tilted by operation of a drive mechanism 46 including a drive motor 48.

The frame 32 mounts a number of solar panels 50 which collectively form the structure for receiving incident sunlight 52 from the sun and reflecting it onto a receiver tube 54 located in a fixed position relative to the frame 32. The solar panels 50 extend between the end walls 38, 40 and are spaced from one another on either side of the receiver tube 54 in a direction toward the side walls 34, 36.

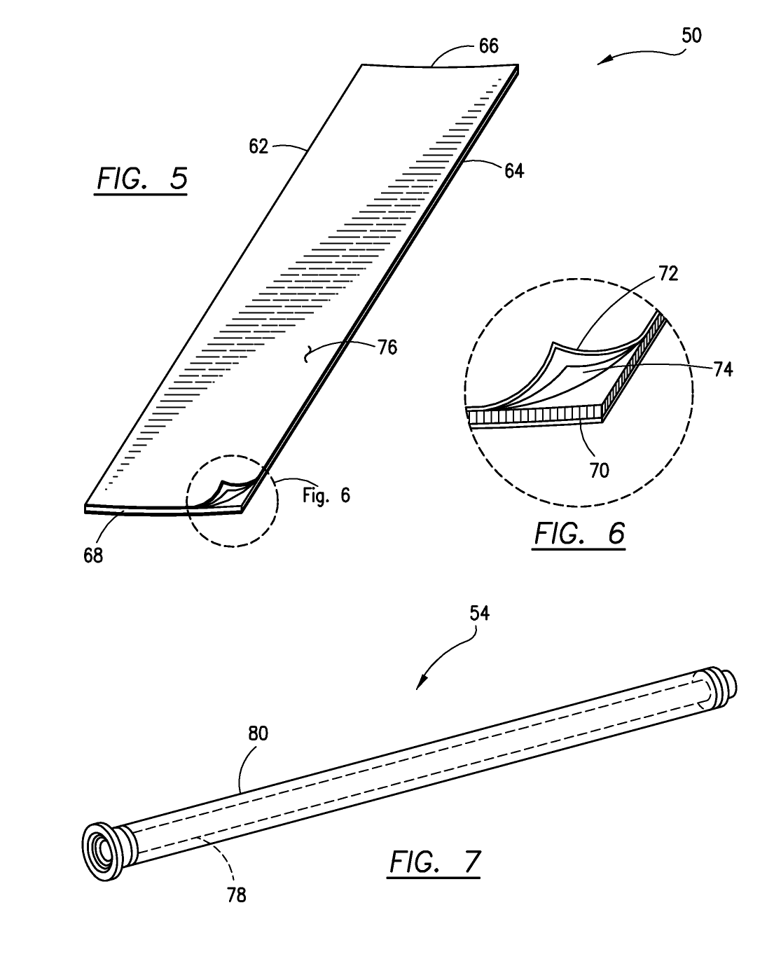

Referring now to FIGS. 5 and 6, a solar panel 50 according to this invention is shown in greater detail. Each solar panel 50 is generally rectangular in shape having opposed side edges 62, 64 and opposed end edges 66, 68. The panels 50 have a slight concave curvature in a direction from one side edge 62 to the other side edge 64, which may be slightly different from one panel 50 to another as described below. Each panel 50 comprises a base section 70, a top section 72 and an intermediate section 74 sandwiched between the sections 70, 72. The base section 70 is preferably formed of a honeycomb aluminum, or similar light-weight, weather resistant and durable material that may be bent in the slight curvature noted above and shown in FIG. 5. The top section 72 is preferably a highly-reflective, silver-metallized film comprising multiple layers of polymer film with an inner layer of pure silver to provide a reflective surface 76 having high specular reflectance. One suitable material for top section 72 is commercially available from ReflecTech, Inc. of Wheat Ridge, Colo. under the trademark “ReflecTech” solar film. The intermediate layer 74 is preferably a layer of pressure sensitive adhesive. Layer 74 may be affixed on one side to the top section 72 and provided with a peel-off backing (not shown) which is removed prior to attachment to the base section 70.

The receiver tube 54 is a component employed in prior art solar collection systems and is readily commercially available. As shown in FIG. 7, it comprises a hollow, stainless steel housing 78 having a solar-selective absorber surface surrounded by an anti-reflective, evacuated glass sleeve 80. A heat transfer fluid such as oil or water is circulated through the housing 78 where it is heated by reflected sunlight, as discussed below. The receiver tube 54 has glass-to-metal seals and metal bellows (not shown) to accommodate differing rates of thermal expansion between the stainless steel housing 78 and glass sleeve 80, and to help maintain the vacuum-tight enclosure. This reduces heat losses at high operating temperatures and protects the solar-select absorber surface of the housing 78 from oxidation.

The solar panels 50 function to direct incident sunlight 53 onto the receiver tube 54 to elevate the temperature of heat transfer fluid circulating within the receiver tube 54 to a level sufficient to operate a steam generator, described below in connection with a discussion of FIG. 12, for the production of electricity. The positioning of the solar panels 50 with respect to the receiver tube 54 is important in maximizing the efficiency of the reflector unit 30. The discussion that follows concerns this aspect of the present invention.

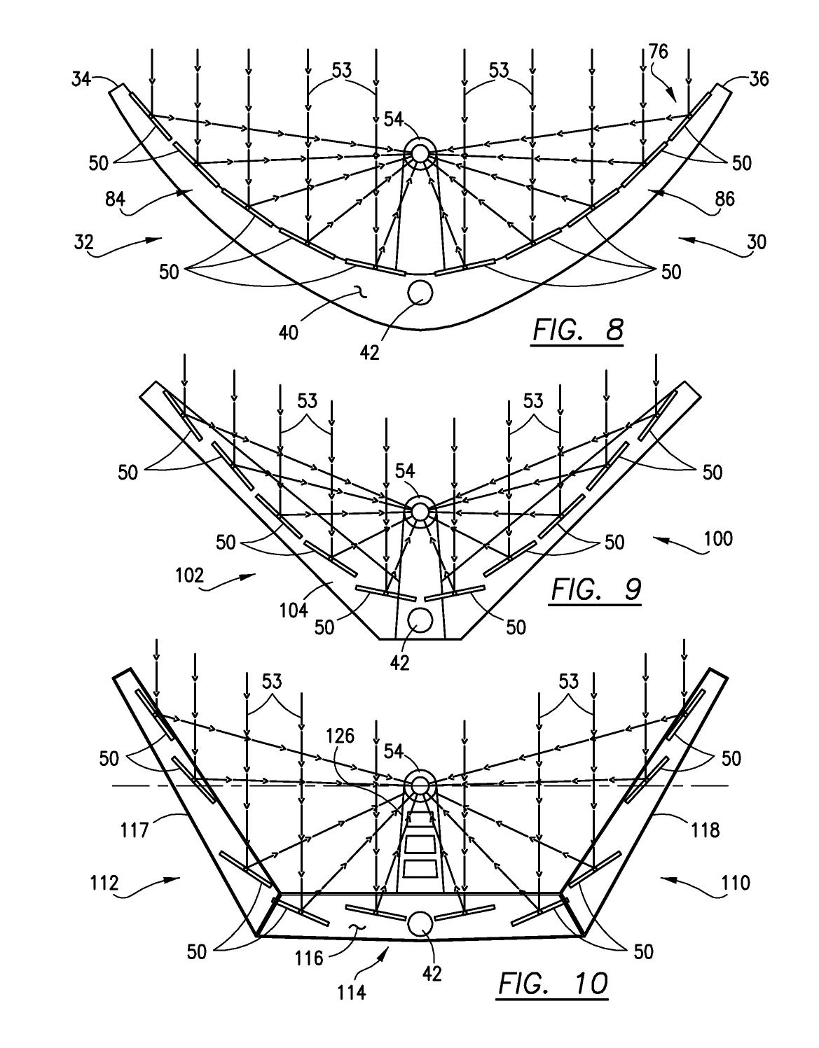

A parabola is a geometric shape defined by the locus of points that are equidistant from a point (the focus) and a focal line (directrix) that lie in the same plane. Referring now to FIG. 8, a schematic end view of the frame 32 is shown with the receiver tube 54 at a location above the reflective surface 76 of the unit 30 and the torsion bar 42 secured to the frame end wall 40. A first array 84 of solar panels 50 extends approximately from the center of the frame 32 to its side wall 34, and a second array 86 of solar panels 50 is mounted between the first array 84 and side wall 36. The end edges 66 and 68 of each panel 50 are secured in a fixed position to an end wall 38 and 40, respectively, of the frame 32 by fasteners such as nuts and bolts (not shown) or other suitable means. The solar panels 50 in each array 84, 86 are oriented at an angle with respect to the receiver tube 54 so as to direct incident sunlight 53 to a focal line or directrix that is coincident with its surface. As seen in FIG. 8, the angle of the solar panels 50 increases from the center of frame 32 outwardly to its side walls 34, 36. In the presently preferred embodiment, the angle of each panel 50 relative to the receiver tube 54 is chosen to closely approximate the orientation of each of a number of discrete segments of a continuous parabola 92. In essence, the solar panels 50 in each array 84, 86 comprise segments of a parabola which are separated from one another, and then individually affixed to the frame 32. Consequently, the solar panels 50 collectively form a reflective, substantially parabolic-shaped surface 76 whose focus and directrix are substantially coincident with the receiver tube 54.

It should be understood that in a true parabola the distance from every point along its surface to the focal point of the parabola is the same. When a parabola is “cut” into segments, e.g. discrete solar panels 50, and then individually mounted to the frame 32 as contemplated in this invention, there must be at least some spacing between the side edges 62, 64 of adjacent solar panels 50 to facilitate mounting and to avoid shadowing or overlap between them. See FIG. 8. The spacing between panels 50, and their linear orientation along the frame 32, both contribute to a change in the distance from the center of each panel 50 to the focus and directrix. Consequently, a slight concave curvature is required in each panel 50, which differs from one panel 50 to another depending on its angulation relative to the secondary reflector 52, in order to ensure that the individual focal point of each panel 50 is substantially the same. Such curvature may be calculated using the standard mathematical equation defining a parabola, namely:

y=x²/4f

Where:
f=the focal point
x=horizontal distance from the center
y=vertical distance

Referring now to FIGS. 9 and 10, alternative embodiments of reflector units according to this invention are schematically illustrated. The reflector unit 100 depicted in FIG. 9 comprises a frame 102 similar to frame 32 described above, except with end walls 104, one of which is shown in FIG. 9, oriented in a generally V-shaped configuration instead of a parabola. Solar panels 50 are positioned at appropriate angles relative to the receiver tube 54 to direct incident sunlight onto its surface. The reflector unit 110 shown in FIG. 10 has a frame 112 with end walls 113 each including a generally horizontally oriented base section 116 and two end sections 117 and 118 extending at an angle relative to the base section 116. A series of solar panels 50 are mounted to the sections 116-118 at angles so as to reflect incident sunlight onto the receiver tube 54.

Referring now to FIGS. 3, 4 and 11, it is advantageous for the solar panels 50 to be oriented substantially perpendicular to the position of the sun throughout the course of a day in order to maximize the efficiency with which the sunlight is reflected onto the receiver tube 54. The frame 32, and, in turn, the solar panels 50, pivot during daylight hours about an axis which is generally coincident with the center of the receiver tube 54. As noted above, the frame 32 is pivoted by a drive mechanism 46 including a motor 48. In the presently preferred embodiment, the pylon 44 rotatably mounts three rollers 120, only two of which are shown, which are spaced approximately 120° apart. These rollers 120 receive and support a drive wheel 122 which is connected by a belt 124 or other suitable drive means to the output shaft of motor 48. The drive wheel 122 is connected to one end of a pivot arm 126 whose opposite end mounts to the frame 32. In response to operation of the motor 48, the drive wheel 122 rotates with respect to the rollers 120. The pivot arm 126 and frame 32 rotate with the drive wheel 122, thus pivoting relative to the pylons 44 to align with the position of the sun during the course of a day. The same construction may be employed for pivoting the frames 102 and 112 of the reflector units 100 and 110, respectively, shown in FIGS. 9 and 10.

In the presently preferred embodiment, the receiver tube 54 remains in a fixed position with respect to the frame 32 and drive wheel 122 throughout the pivotal motion of the frame 32. The receiver tube 54 extends through an opening in the pivot arm 126, and an opening in the drive wheel 122 where it is received and supported by a bearing that allows the receiver tube 54 to remain in a fixed position during rotation of the drive wheel 122. This construction has the advantage of allowing the receiver tube 54 to be connected to a fixed transfer conduit 128, schematically illustrated in FIG. 12, coupled to a steam generator as described below. Consequently, the expensive and leak-prone connections between the moving receiver tubes and transfer conduits employed in the prior art, and shown, for example, in FIG. 2, are eliminated in this invention.

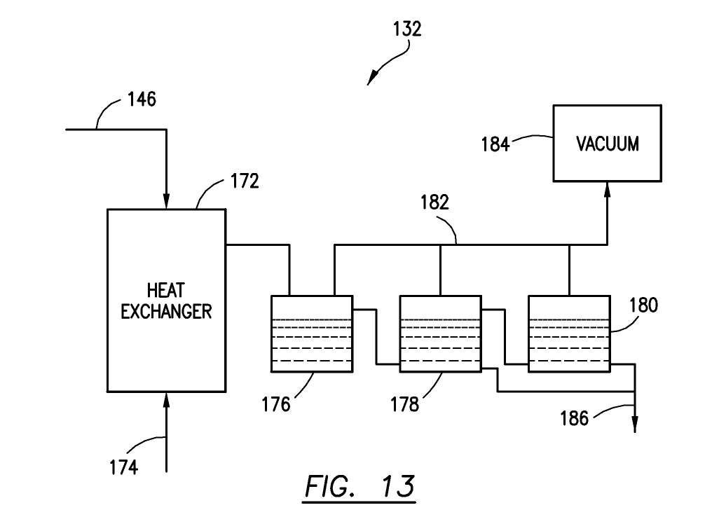

Referring now to FIGS. 12 and 13, schematic views are provided of a system 130 for the generation of electrical power employing the reflector units 30 of this invention, and the use of waste heat from the system 130 to operate a desalination device 132. An number of reflector units 30 (or reflector units 100 or 110) may be placed in a compact array forming a solar field 134, typically occupying 10 acres of land or less, preferably at a location near a load center such as a small town, factory or the like (not shown). The reflector units 30 are conventionally aligned on a north-south horizontal axis, and track the sun as it moves from east to west during the day as discussed above. The receiver tubes 54 of the individual reflector units 30 are connected by the transfer conduit 128 to heat exchangers within the steam generator 138 which receive heat transfer fluid from the reflector units 30 typically at a temperature in excess of 200° C. The steam generator 138 is operative to produce saturated steam which is transmitted via line 140 to a turbine 142. The turbine 142, in turn, is coupled to an electric generator 144 to produce electricity, e.g. on the order of about 2.5 to 5 megawatts.

In one embodiment of this invention, the exhaust steam from the turbine 142 is directed through line 146 to a condenser 148 and then returned to the steam generator 138 via condensate line 150 and feed water pump 152 where it is transformed back to steam. The condenser 148 may be connected to a cooling tower 154 via lines 156 and 158, and pump 159, to convert the steam from turbine 142 to water. The heat transfer fluid from the outlet of the receiver tubes 54 in the solar field 134 is returned from the steam generator 138 to the inlet end of such tubes via line 160 and pump 162. A network of valves 164 may be provided to input the heat transfer fluid directly into the heat exchangers of the steam generator 138, or into a thermal storage tank 166. The tank 166 can be used as a buffer to reduce fluctuations due to cloud cover, or to extend the hours of operation of the system 130 from solar energy. Additionally, an auxiliary heater 168, such as a natural gas heater, may be connected to the line 128 through valves 164 to extend the hours of operation of the system 130 up to 24 hours per day.

In an alternative embodiment of this invention, the “waste heat” produced by the turbine 142, e.g. excess steam and heated water, may be employed as a distributed source of energy for auxiliary applications such as the desalination device 132, for the heating of buildings and for a variety of other applications. As schematically depicted in FIGS. 12 and 13, excess steam from the turbine 142 may be directed through a valve 164 to an auxiliary device such as the desalination system 132, shown in FIG. 13, which is one example of a distributed generation application. The waste heat from turbine 142 is transmitted into a heat exchanger 172 employed in the desalination device 132. Seawater enters the heat exchanger 172 via line 174 and is then transmitted into a series of tanks 176, 178 and 180 connected by a line 182 to a source of vacuum 184. In the course of passage through tanks 176-180, fresh water is separated from the brine and discharged through line 186.

As noted above, the distributed generation provided by the system 130 of this invention is made possible by its compact size and environmentally friendly construction. Unlike fossil fuel power generation systems, the system 130 of this invention may be located in close proximity to load centers the avoiding the difficulty and cost of transmission, and also making available the waste heat produced for distributed generation applications.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A concentrated solar power generation system, comprising:
a number of solar energy collectors, each of said collectors comprising:
(i) a frame;
(ii) a number of solar panels each having a reflective surface, said solar panels being mounted to said frame in position to reflect sunlight incident on said reflective surface thereof;
(iii) a receiver tube within which a heat transfer fluid is circulated, said receiver tube being located relative to said solar panels to receive reflected sunlight so that said heat transfer fluid within said receiver tube is heated, said receiver tube having an inlet and an outlet;
a steam generator coupled to said outlet of said receiver tube of each of said collectors, said steam generator being effective to receive heated heat transfer fluid from said receiver tubes and to produce steam;
a turbine coupled to said steam generator, said turbine having an outlet through which waste heat is discharged;
an electric generator coupled to said turbine and being effective to produce electric energy;
an auxiliary device coupled to said outlet of said turbine, said auxiliary device receiving waste heat from said turbine for use in distributed generation applications.

2. The system of claim 1 in which said auxiliary device is a water desalination system.

3. The system of claim 1 in which said auxiliary device is a heating system for a building.

4. The system of claim 1 in which said solar panels of each collector are oriented at an angle relative to said receiver tube to collectively form a parabolic-shaped surface for the reflection of sunlight onto said receiver tube.

5. The system of claim 1 in which said solar panels of said collectors each comprise a first section formed of honeycomb aluminum, a second section having said reflective surface and a third section connecting said first section to said second section.

6. The system of claim 5 in which said first section of honeycomb aluminum has opposed ends and opposed sides, said first section being formed in a concave shape between said opposed sides.

7. The system of claim 1 further including a thermal storage tank coupled to said outlet of said receiver tube of each of said collectors.

8. The system of claim 1 further including a heater coupled to said outlet of said receiver tube of each of said collectors.

9. The system of claim 1 in which said frame of each of said collectors is pivoted to track the movement of the sun during the course of a day, said frame being pivoted relative to said receiver tube which is mounted in a fixed position.

10. A concentrated solar power generation system, comprising:
a number of solar energy collectors, each of said collectors comprising:
(i) a frame;
(ii) a number of solar panels, each of said solar panels including a first section formed of a light-weight honeycomb structure, a second section having a reflective surface and a third section connecting said first and second sections, said solar panels being mounted to said frame in position to reflect sunlight incident on said reflective surface thereof;
(iii) a receiver tube within which a heat transfer fluid is circulated, said receiver tube being located relative to said solar panels to receive reflected sunlight so that said heat transfer fluid within said receiver tube is heated, said receiver tube having an inlet and an outlet;
a steam generator coupled to said outlet of said receiver tube of each of said collectors, said steam generator being effective to receive heated heat transfer fluid from said receiver tubes and to produce steam;
a turbine coupled to said steam generator, said turbine having an outlet through which waste heat is discharged;
an electric generator coupled to said turbine and being effective to produce electric energy;
an auxiliary device coupled to said outlet of said turbine, said auxiliary device receiving waste heat from said turbine for use in distributed generation applications.

11. The system of claim 10 in which said light-weight honeycomb structure is honeycomb aluminum.

12. The system of claim 10 in which said solar panels of each collector are oriented at an angle relative to said receiver tube to collectively form a parabolic-shaped surface for the reflection of sunlight onto said receiver tube.

13. The system of claim 10 further including a thermal storage tank coupled to said outlet of said receiver tube of each of said collectors.

14. The system of claim 1 further including a heater coupled to said outlet of said receiver tube of each of said collectors.

15. The system of claim 10 in which said frame of each of said collectors is pivoted to track the movement of the sun during the course of a day, said frame being pivoted relative to said receiver tube which is mounted in a fixed position.
